(19) United States
(12) Patent Application Publication
(10) Pub. No.: US 2013/0337182 A1
(43) Pub. Date: Dec. 19, 2013

(54) METHOD FOR PREPARING WOVEN FABRIC EXCELLENT IN DEODORIZING AND COOLING EFFECTS

(71) Applicant: Myung Whan KIM, Seoul (KR)

(72) Inventor: Myung Whan KIM, Seoul (KR)

(21) Appl. No.: 13/523,531

(22) Filed: Jun. 14, 2012

(51) Int. Cl. B05D 3/02

(52) U.S. Cl. 427/394; 427/372.2

(57) ABSTRACT

A method for preparing a woven fabric excellent in deodorizing and cooling effects and, more particularly to, a method for preparing a woven fabric excellent in deodorizing and cooling effects that includes: a cooling composition preparation step for blending a component providing a feeling of coolness to prepare a cooling composition; a cooling composition applying step for applying the cooling composition of the cooling composition preparation step onto a woven fabric; a deodorizing component applying step for applying a deodorizing component onto the woven fabric coated with the cooling composition in the cooling composition applying step; and a drying step for drying the woven fabric coated with the deodorizing component in the deodorizing component applying step. The woven fabric prepared by the procedures is coated with a deodorizing component and a cooling composition and thus excellent in the deodorizing and cooling effects.

### BACKGROUND OF THE INVENTION

1. Field of the Invention

The present invention relates to a method for preparing a woven fabric excellent in deodorizing and cooling effects and, more particularly, to a method for preparing a woven fabric excellent in deodorizing and cooling effects, which woven fabric is coated with a deodorizing component and a cooling composition to have good deodorizing and cooling effects.

2. Background Art

The present invention is directed to a method for preparing a woven fabric excellent in deodorizing and cooling effects and, more particularly, to a method for preparing a woven fabric coated with a deodorizing component and a cooling composition and thus excellent in deodorizing and cooling effects.

The conventional cooling component is usually a sugar alcohol, which contains no free carbonyl group, causing no maillard denaturation to occur. In contrast to other monosaccharides or disaccharides, the sugar alcohol is stable under heat, not susceptible to degradation by microorganisms, and high in heat absorption in the solution state, providing a feeling of coolness. The sugar alcohol is a functional sugar for prevention of dental caries and low-calories diet and used as a substitute sweetener for sugar in a variety of applications, such as foods, medical products, cosmetics, and so forth. Particularly, the sugar alcohol has a high heat of dissolution and thus serves to enhance the feeling of coolness when dissolved in saliva or sweat.

The cooling effect of the sugar alcohol is used in Korean Patent No. 10-0516955 (filed on Sep. 15, 2005), disclosing a woven or knitted fabric having a cooling effect that is prepared by impregnating a blended woven or knitted fabric of silver fibers or a blended yarn of silver fibers having a fineness of 0.1 to 120 deniers with a cooling component comprising 25 to 50 wt. % of xylitol, 20 to 45 wt. % of erythritol, 10 to 30 wt. % of squalene, 2 to 10 wt. % of silk protein, and 3 to 15 wt. % of monoglyceride; Korean Patent No. 10-2010-0048750 (filed on May 11, 2010), disclosing a scarp having a cooling effect that includes a cooling band containing a highly water-absorbent polymer packed in a cooling fabric, which cooling band is provided at a defined position of the scarp, the cooling fabric containing 1 to 10 wt. % of xylitol or erythritol as a cooling component; or Korean Patent No. 10-2010-0048749 (filed on May 11, 2010), disclosing a cap comprising a sunlight-blocking portion and a wearing portion for receiving the user's head, where the inner side of the wearing portion has a cooling band containing a highly water-absorbent polymer packed in a cooling fabric, the cooling fabric containing 1 to 10 wt. % of xylitol or erythritol as a cooling component.

These related arts can provide a feeling of coolness to some extent, but with a limitation in maintaining the feeling of coolness. The cooling composition problematically causes skin irritations when in contact with the skin and cannot provide an effect of health promotion such as prevention of skin cancer caused by UV radiation other than the cooling effect.

Further, the woven fabric providing a feeling of coolness possibly emits offensive odors in association with excessive perspiration in summer.

### SUMMARY OF THE INVENTION

Accordingly, it is an object of the present invention to provide a method for preparing a woven fabric excellent in deodorizing and cooling effects, which woven fabric can give a feeling of coolness for a long duration without causing skin irritations when in contact with the skin and provide a good deodorizing effect.

It is another object of the present invention to provide a method for preparing a woven fabric excellent in deodorizing and cooling effects, which woven fabric has a function of preventing skin cancer with a coating of a UV blocking agent as well as a cooling function.

It is still another object of the present invention to provide a method for preparing a woven fabric excellent in deodorizing and cooling effects, which woven fabric contains a deodorizing component and a deodorant powder to provide a deodorizing function and prevent excessive perspiration.

To accomplish the above objects, according to the present invention, there is provided a method for preparing a woven fabric excellent in deodorizing and cooling effects, comprising: a cooling composition preparation step for blending a component providing a feeling of coolness to prepare a cooling composition; a cooling composition applying step for applying the cooling composition of the cooling composition preparation step onto a woven fabric; a deodorizing component applying step for applying a deodorizing component onto the woven fabric coated with the cooling composition in the cooling composition applying step; and a drying step for drying the woven fabric coated with the deodorizing component in the deodorizing component applying step.

In accordance with a preferred embodiment of the present invention, the method further comprises, between the deodorizing component applying step and the drying step, applying a UV blocking component onto the absorbent woven fabric coated with the deodorizing component in the deodorizing component applying step.

In accordance with a further preferred embodiment of the present invention, the cooling composition comprises 100 parts by weight of an organic acid, 50 to 80 parts by weight of an oil component, 60 to 90 parts by weight of a silicon softener, and 5 to 50 parts by weight of purified water.

In accordance with a still further preferred embodiment of the present invention, the oil component comprises at least one selected from the group consisting of olive oil, grape seed oil, coconut oil, Evening Primrose oil, palm oil, johoba oil, and corn oil.

In accordance with a still further preferred embodiment of the present invention, the organic acid comprises at least one or two selected from the group consisting of citric acid, malic acid, lactic acid, tartaric acid, succinic acid, gluconic acid, ascorbic acid, oxalic acid, malonic acid, glutaric acid, adipic acid, maleic acid, itaconic acid, and propionic acid.

In accordance with a still further preferred embodiment of the present invention, the cooling composition further comprises 50 to 60 parts by weight of at least one cooling component selected from the group consisting of erythritol, xylitol, maltitol, mannitol, isomalt, stevioside, tomatin, D-xylose, D-ribose, and L-sorbose.

In accordance with a still further preferred embodiment of the present invention, the woven fabric comprises an acrylic acid/acrylate copolymer.

In accordance with a still further preferred embodiment of the present invention, the deodorizing component comprises at least one selected from the group consisting of a titanium compound, saponin, a cryptomeria japonica leaf extract, sorbitol, terpene, camphor, and flavonoid.

In accordance with a still further preferred embodiment of the present invention, the deodorizing component further comprises a deodorant powder.

In accordance with a still further preferred embodiment of the present invention, the drying step is conducted using a tumble dryer at 110 to 150° C. for 10 to 30 minutes.

The method for preparing a woven fabric excellent in deodorizing and cooling effects according to the present invention can effectively provide a woven fabric that gives a feeling of coolness for a long duration without causing irritations on the skin when in contact with the skin and provides a good deodorizing effect.

The method of the present invention can also provide a woven fabric that has a function of preventing occurrence of skin cancer with a coating of a UV blocking agent as well as a cooling effect.

The method of the present invention can also provide a woven fabric that contains a deodorizing component and a deodorant powder to provide a deodorizing effect and prevent excessive perspiration.

### BRIEF DESCRIPTION OF THE DRAWINGS

FIG. 1 is a flow chart showing a method for preparing a woven fabric excellent in deodorizing and cooling effects in accordance with an embodiment of the present invention.

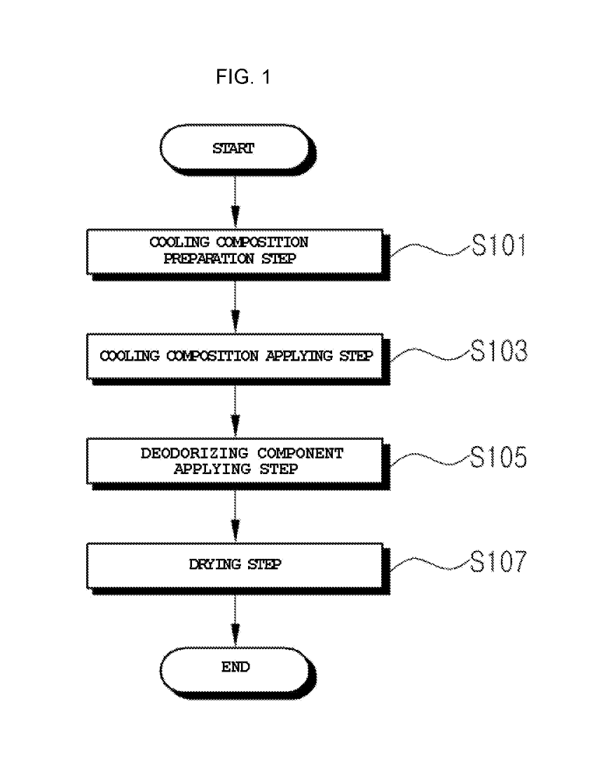

FIG. 2 is a flow chart showing a method for preparing a woven fabric excellent in deodorizing and cooling effects in accordance with another embodiment of the present invention.

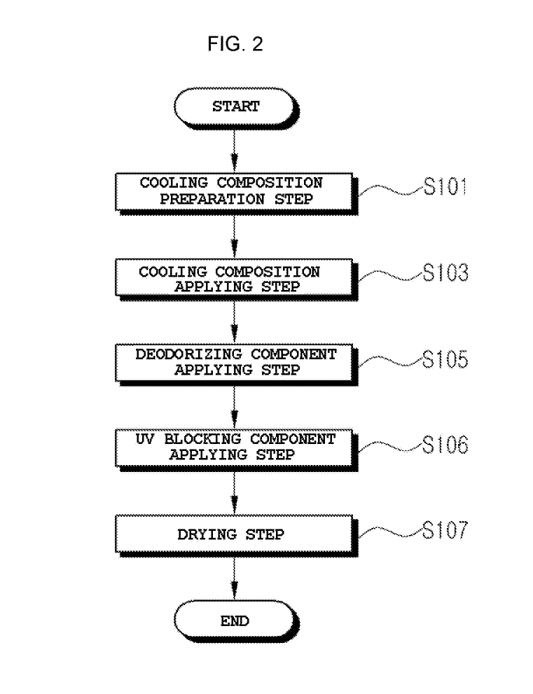

### DETAILED DESCRIPTION OF THE PREFERRED EMBODIMENT

Hereinafter, the preferred embodiments of the present invention and the properties of each component will be described in detail, which are for illustrations only for the skilled in the art to realize the present invention with ease and not intended to limit the spirit and scope of the present invention.

The method for preparing a woven fabric excellent in deodorizing and cooling effects according to the present invention comprises: a cooling composition preparation step for blending a component providing a feeling of coolness to prepare a cooling composition; a cooling composition applying step for applying the cooling composition of the cooling composition preparation step onto a woven fabric; a deodorizing component applying step for applying a deodorizing component onto the woven fabric coated with the cooling composition in the cooling composition applying step; and a drying step for drying the woven fabric coated with the deodorizing component in the deodorizing component applying step.

The cooling composition preparation step S101 is blending a component for providing a feeling of coolness to prepare a cooling composition. The step S101 includes adding 100 parts by weight of an organic acid, 50 to 80 parts by weight of an oil component, 60 to 90 parts by weight of a silicon softener, and 5 to 50 parts by weight of purified water into an agitator to prepare a cooling composition under agitation.

The content of the organic acid less than 100 parts by weight deteriorates the cooling effect to reduce the feeling of coolness, whereas the content of the organic acid greater than 100 parts by weight deteriorates the solubility. The organic acid comprises at least one or two selected from the group consisting of citric acid, malic acid, lactic acid, tartaric acid, succinic acid, gluconic acid, ascorbic acid, oxalic acid, malonic acid, glutaric acid, adipic acid, maleic acid, itaconic acid, and propionic acid. Such an organic acid comprising those components participates in endothermic reaction with water in the body fluid to lower the body temperature on the surface of the skin. Among the organic acids, citric acid is particularly superior in adhesiveness to an object and heat-absorbing characteristic.

The oil component, containing natural vitamins and antioxidants, is very effective in skin hydration and anti-aging and used in an amount of 50 to 80 parts by weight. The content of the oil component less than 50 parts by weight provides an insignificant effect of skin hydration or anti-aging, whereas the content of the oil component greater than 80 parts by weight deteriorates the stability of the cooling component and increases the production cost.

Preferably, the oil component comprises at least one selected from the group consisting of olive oil, grape seed oil, coconut oil, Evening Primrose oil, palm oil, johoba oil, and corn oil. More preferably, the oil component comprises olive oil and grape seed oil.

The olive oil, containing natural vitamins and antioxidants, is an ingredient very effective in prevention of liver spots, skin blemish, or freckles and anti-aging. The grape seed oil is very effective in skin hydration and anti-aging due to plentiful vitamin E and tocopherol to keep the elasticity of the skin and beneficial to a horny or rough skin with its content of AHA as a kind of fruit acids.

The softener, comprising a silicon-based softener, serves to help the organic acid or the oil component adhere to a woven fabric and provides very beneficial effects to the skin as well as softness to the woven fabric. The content of the softener less than 60 parts by weight deteriorates the adhesiveness of the organic acid and the oil component to a woven fabric to reduce the durability, whereas the content of the softener greater than 90 parts by weight deteriorates the storage stability and hence the heat-absorbing effect of the cooling composition.

The cooling composition may further comprise 50 to 60 parts by weight of at least one cooling component selected from the group consisting of erythritol, xylitol, maltitol, mannitol, isomalt, stevioside, tomatin, D-xylose, D-ribose, and L-sorbose. Such a cooling composition that further comprises the cooling component has a high heat of dissolution and thus serves to enhance the feeling of coolness when dissolved in saliva or sweat.

The cooling composition applying step S103 is to apply the cooling composition prepared in the cooling composition preparation step S101 onto a woven fabric. In the cooling composition applying step S103, the cooling composition is applied to the surface of the woven fabric by spraying it on the woven fabric or soaking the woven fabric with it.

The amount of the cooling composition used in the cooling composition applying step S103 is preferably in the range of 60 to 80 parts by weight with respect to 100 parts by weight of the woven fabric.

The woven fabric as used herein may include any woven fabric comprised of different yarns, such as natural fiber yarn, blended yarn, synthetic fiber yarn, etc. Preferably, the woven fabric is comprised of a synthetic fiber yearn. The heat absorption performance can increase when the cooling composition is applied to the woven fabric comprising a blended yarn or a synthetic fiber yarn, including amide-based fibers (e.g., nylon), polyester-based fibers, or polyurethane-based fibers.

In particular, the use of bamboo fibers or a blended yarn of bamboo fibers and synthetic fibers can acquire a drop of temperature about 1.5 to 5° C. The amount of the cooling composition to apply to the woven fabric is appropriately controlled depending on the type of the woven fabric. When it comes to soaking the woven fabric with the cooling composition, it is preferable to use an aqueous solution containing the cooling composition 5 to 10% in concentration.

The woven fabric may use an acrylic acid acrylate copolymer excellent in water absorption. The woven fabric made of an acrylic acid acrylate copolymer has high water absorption and can be used in contact with cool water to absorb cool water. The acrylic acid acrylate copolymer absorbing cool water releases the heat emitted from the body to enhance the cooling effect.

The deodorizing component applying step S105 is applying a deodorizing component onto the woven fabric coated with the cooling composition in the cooling composition applying step S103. For this, 5 to 20 parts by weight of a deodorizing component is sprayed on 100 parts by weight of the woven fabric coated with the cooling composition in the cooling composition applying step S103, to suppress odor emission caused by the sweat from the body in summer.

If not including the deodorizing component, the woven fabric prepared by the method for preparing a woven fabric excellent in deodorizing and cooling effects can have a shorter wash time cycle, which results in a reduced release time of the cooling composition applied on the surface of the woven fabric by wash, reducing the period of time for providing the feeling of coolness.

Preferably, the deodorizing component comprises at least one selected from the group consisting of a titanium compound, saponin, a cryptomeria japonica leaf extract, sorbitol, terpene, camphor, and flavonoid. The deodorizing component may further comprise 50 to 60 parts by weight of a deodorant powder for preventing excessive perspiration, which content is given with respect to 100 parts by weight of the deodorizing component.

The drying step S107 is drying the woven fabric coated with the deodorizing component in the deodorizing component applying step S105. In this step S107, the woven fabric coated with the deodorizing component is dried after dehydration with a dehydrating means such as padding rollers, to more firmly adhere the cooling composition to the woven fabric through a crosslinking effect of the silicon resin contained in the cooling composition.

The drying step S107 is preferably conducted using a tumble dryer at 110 to 150° C. for 10 to 30 minutes.

The drying step S107 ends up with a woven fabric excellent in deodorizing and cooling effects, and a wearing of clothing made of the woven fabric can reduce the body temperature as the cooling composition applied to the woven fabric reacts with the body fluid to reduce the temperature of the skin. The decrease in the body temperature caused by the cooling composition is in the range of about 0.5 to 5° C., and the cooling effect lasts during the wearing of clothing.

Further, the cooling composition and the deodorizing component applied to the woven fabric provide durability high enough to maintain the feeling property even after 30 times of wash and give antibacterial and anti-humidity effects as well as the deodorizing effect, realizing a refreshing feeling during a wearing of clothing.

Between the deodorizing component applying step S105 and the drying step S107 is provided a UV blocking component applying step S106 for applying a UV blocking component to the woven fabric coated with the deodorizing component in the deodorizing component applying step S105. This step S106 is spraying 2.5 to 10 parts by weight, preferably 5 parts by weight of a UV blocking component on 100 parts by weight of the woven fabric coated with the deodorizing component in the deodorizing component applying step S105.

The UV blocking component plays a role of skin protection against UV light and comprises at least one selected from the group consisting of padimate O, octinoxate (octyl methoxycinnamate), octisalate (octyl salicylate), octocrylene, ensulizole (phenylbenzimidazole sulfonic acid), oxybenzone, meradimate (methyl anthranilate), avobenzone (butyl methoxydibenzoylmethane), titanium dioxide, and zinc oxide.

Hereinafter, a description will be given as to the heat absorption effect of a woven fabric prepared by the method for preparing a woven fabric excellent in deodorizing and cooling effects according to the present invention by way of examples.

### Example 1

75 parts by weight of a silicon-based softener and 65 parts by weight of an oil component comprised of olive oil and grape seed oil were put in a homogenizer and stirred at high rate of 4000 rpm for about 60 minutes to prepare an emulsion solution. In a container equipped with a separate agitator, 100 parts by weight of citric acid was completely dissolved in about 25 parts by weight of purified water under agitation. The emulsion solution was added to the mixture of purified water and citric acid for about 30 minutes, and the resultant mixture was stirred at 400 rpm for 60 minutes to prepare a cooling composition. 70 parts by weight of the cooling composition was spray-coated with a sprayer on 100 parts by weight of a woven fabric (polyester-polyurethane blended tricot fabric: polyester 77%, 20D polyurethane 23%, weight 148.2 g/m² as measured by ks K 0514:2006). Then, 10 parts by weight of a deodorizing component comprised of a titanium compound was applied to 100 parts by weight of the woven fabric coated with the cooling composition. The woven fabric coated with the deodorizing component was dried out in a tumble drier at 130° C. for 20 minutes to produce a woven fabric excellent in deodorizing and cooling effects.

### Example 2

The procedures were performed in the same manner as described in Example 1, excepting that malic acid was used instead of citric acid, to prepare a woven fabric excellent in deodorizing and cooling effects.

### Example 3

The procedures were performed in the same manner as described in Example 1, excepting that a blended yarn of bamboo fibers and nylon fibers (bamboo fibers 60%, nylon fibers 40%, 200 TM) was used, to prepare a woven fabric excellent in deodorizing and cooling effects.

### Example 4

The procedures were performed in the same manner as described in Example 1, excepting that an acrylic acid acrylate copolymer was used as the woven fabric, to prepare a woven fabric excellent in deodorizing and cooling effects.

### Example 5

The procedures were performed in the same manner as described in Example 1, excepting that 55 parts by weight of xylitol was added to the cooling composition, to prepare a woven fabric excellent in deodorizing and cooling effects.

### Example 6

The procedures were performed in the same manner as described in Example 1, excepting that 55 parts by weight of xylitol was added to the cooling composition and that an acrylic acid acrylate copolymer was used as the woven fabric, to prepare a woven fabric excellent in deodorizing and cooling effects.

The woven fabrics prepared in Examples 1 to 6 were made into shirts, each of which was put on a thermal manikin to measure the change of temperature on the thermal manikin. The measurement results are presented in Table 2.

The change of temperature was measured using a thermal manikin (Newton, MTNW) equipped with a skin thermo-hydrometer (LT-8B, Gram) in an environment simulation chamber (EBE Walk-in, ESPEC).

The testing procedures were as follows:

(a) Set the temperature and humidity of an environment simulation chamber as designated by a requester: 32±2° C., 50±4% R.H.
(b) Wash the shirt given by the requester 30 times according to the ISO 6330-9B method.
(c) With the shirt put on a thermal manikin, attach a thermometer between the thermal manikin and the shirt.
(d) Stabilize the thermal manikin with the shirt on for 30 minutes.
(e) Operate the thermal manikin at a sweating rate of 500 ml/m²/hr.
(f) Measure the temperature of a sample for 120 minutes.

TABLE 2

Elapsed Time (min)

| | | | | | |
|---|---|---|---|---|---|
| 0 | 30 | 60 | 90 | 120 | 150 |

| | |
|---|---|
| Div. | Shirt Temperature (° C.) |

| | | | | | | |
|---|---|---|---|---|---|---|
| Example 1 | 32.01 | 32.08 | 24.29 | 23.80 | 23.32 | 23.16 |
| Example 2 | 32.03 | 32.07 | 24.33 | 23.78 | 23.29 | 23.18 |
| Example 3 | 31.08 | 32.01 | 23.09 | 22.98 | 22.89 | 22.81 |
| Example 4 | 31.05 | 31.79 | 23.03 | 23.01 | 22.77 | 22.25 |
| Example 5 | 31.96 | 31.83 | 24.01 | 23.56 | 23.02 | 22.96 |
| Example 6 | 30.08 | 29.98 | 22.97 | 22.76 | 22.54 | 22.31 |

As can be seen from Table 2, the shirts made of the woven fabrics prepared by the method for preparing a woven fabric excellent in deodorizing and cooling effects according to the present invention had a good cooling performance with an elapse of time.

Further, the woven fabric, which is comprised of components causing no skin irritation when in contact with the skin, causes no skin irritation, maintains a cooling effect even after 30 times of wash and has a good deodorizing effect.

Aside from the cooling effect, the woven fabric can suppress occurrence of skin cancer with a coating of a UV blocking component and prevent excessive perspiration due to an addition of a deodorant powder.

What is claimed is:

1. A method for preparing a woven fabric excellent in deodorizing and cooling effects, comprising:
a cooling composition preparation step for blending a component providing a feeling of coolness to prepare a cooling composition;
a cooling composition applying step for applying the cooling composition of the cooling composition preparation step onto a woven fabric;
a deodorizing component applying step for applying a deodorizing component onto the woven fabric coated with the cooling composition in the cooling composition applying step; and
a drying step for drying the woven fabric coated with the deodorizing component in the deodorizing component applying step.

2. The method as claimed in claim 1, further comprising:
between the deodorizing component applying step and the drying step, applying a UV blocking component onto the absorbent woven fabric coated with the deodorizing component in the deodorizing component applying step.

3. The method as claimed in claim 1, wherein the cooling composition comprises 100 parts by weight of an organic acid, 50 to 80 parts by weight of an oil component, 60 to 90 parts by weight of a silicon softener, and 5 to 50 parts by weight of purified water.

4. The method as claimed in claim 3, wherein the oil component comprises at least one selected from the group consisting of olive oil, grape seed oil, coconut oil, Evening Primrose oil, palm oil, johoba oil, and corn oil.

5. The method as claimed in claim 3, wherein the organic acid comprises at least one or two selected from the group consisting of citric acid, malic acid, lactic acid, tartaric acid, succinic acid, gluconic acid, ascorbic acid, oxalic acid, malonic acid, glutaric acid, adipic acid, maleic acid, itaconic acid, and propionic acid.

6. The method as claimed in claim 5, wherein the cooling composition further comprises 50 to 60 parts by weight of at least one cooling component selected from the group consisting of erythritol, xylitol, maltitol, mannitol, isomalt, stevioside, tomatin, D-xylose, D-ribose, and L-sorbose.

7. The method as claimed in claim 1, wherein the woven fabric comprises an acrylic acid/acrylate copolymer.

8. The method as claimed in claim 1, wherein the deodorizing component comprises at least one selected from the group consisting of a titanium compound, saponin, a cryptomeria japonica leaf extract, sorbitol, terpene, camphor, and flavonoid.

9. The method as claimed in claim 8, wherein the deodorizing component further comprises a deodorant powder.

10. The method as claimed in claim 1, wherein the deodorizing component further comprises a deodorant powder.

11. The method as claimed in claim 1, wherein the drying step is conducted using a tumble dryer at 110 to 150° C. for 10 to 30 minutes.
